(19) United States
(12) Patent Application Publication
(10) Pub. No.: US 2026/0078763 A1
(43) Pub. Date: Mar. 19, 2026

(54) SMART FAN COMPATIBLE WITH VARIOUS CONTROL BOX

(71) Applicant: PROLIFIC TECHNOLOGY INC., Taipei City (TW)

(72) Inventors: CHIA-CHANG HSU, Hsinchu County (TW); REN-YUAN YU, Hsinchu County (TW)

(73) Assignee: PROLIFIC TECHNOLOGY INC., Taipei City (TW)

(21) Appl. No.: 19/322,862

(22) Filed: Sep. 9, 2025

(30) Foreign Application Priority Data
Sep. 13, 2024 (TW) 113134979

(51) Int. Cl. F04D 27/00; F21V 33/00; F21Y 115/10

(52) U.S. Cl. CPC F04D 27/005; F04D 27/004; F21V 33/0096; F21Y 2115/10

(57) ABSTRACT

A smart fan compatible with various cooling fan control box is disclosed. The smart fan has an electronic chip and at least one connector. In case of the electrical connector being connected to a control box, the electronic chip switches the smart fan to a normal control mode or a data packet transmission mode. In the normal control mode, a priority identifier or a non-priority identifier of the smart fan is firstly set, and then the smart fan is controlled so as to operate in the normal control mode. In addition, after being switched to the data packet transmission mode, the control box and the smart fan conduct a data packet transmission according to a specific communication protocol, such that a rotation speed control, a rotation speed monitoring and a function setting of the smart fan can be carried out.

### CROSS-REFERENCE TO RELATED APPLICATIONS

This This application claims the priority and benefit of Taiwan patent application No. 113134979, filed on Sep. 13, 2024, the entire contents of which are incorporated herein by reference.

### BACKGROUND OF THE INVENTION

### 1. Field of the Invention

The present invention relates to the technology filed of cooling fans, and more particularly, to a smart fan compatible with various control box.

### 2. Description of the Prior Art

With reference to FIG. 1, a traditional cooling fan 1a is well known that includes a signal cable connected with an electrical connector 12a. A user who has ever installed at least one the traditional cooling fan 1a in a computer case certainly knows that the electrical connector 12a commonly has four pins, i.e., PWM pin, Tach pin (or called as FG pin), power supply pin, and ground pin. Accordingly, a mother board disposed in the computer case is provided with at least one 4-pin male fan header thereon, such that the electrical connector 12a can be, by the user, subsequently connected to the 4-pin male fan header after the traditional cooling fan 1a is fixed on the computer case.

On the other hand, FIG. 2 illustrates a top view of a currently popular ARGB case fan. Differing from the aforesaid traditional cooling fan 1a, as FIG. 2 shows that at least one LED lighting unit 10b comprising a plurality of LED components is disposed on a frame of the ARGB case fan 1b. Therefore, for simultaneously controlling the rotation of a fan blade and the light emitting of the LED lighting unit 10b, the ARGB case fan 1b is provided with a first signal cable 11b and a second signal cable 12b, of which the first signal cable 11b and the second signal cable 12b are connected with a first electrical connector 13b and a second electrical connector 14b, respectively. To be more specific, the first electrical connector 13b has a PWM pin, a Tach pin, a power supply pin, and a ground pin, and the second electrical connector 14b may be provided with four pins (12V4P) or three pins (5V3P) according to the driving voltage. Accordingly, the mother board disposed in the computer case is hence provided with at least one 4-pin male fan header and at least one 3-pin male fan header thereon, such that the first electrical connector 13b and the second electrical connector 14b can be, after the ARGB case fan 1b is fixed on the computer case, subsequently connected to the 4-pin male fan header and the 3-pin male fan header, respectively.

As explained in more detail, with the significant enhance in the computing speed of CPU and GPU as well as the increase in a total use number of solid-state drives in the mother board, there is a need for the user to install multiple numbers of the traditional cooling fans 1a and/or the ARGB case fans 1b in the computer case. However, owing to the fact that the mother board has a limited number of the 4-pin male fan headers and the 3-pin male fan headers, there is correspondingly a limited number of the traditional cooling fans 1a and/or the ARGB case fans 1b that the user can be installed in the computer case. In accordance with this reason, a cooling fan control box (or called as cooling fan control hub) is therefore developed and rolled out. With reference to FIG. 3, the cooling fan control box 2a commonly comprises a housing case (not depicted in FIG. 3) and a controller module, of which the controller module 2a comprises a PCB 21a, at least one MCU 22a, multiple 4-pin male fan headers 23a, multiple 3-pin male fan headers 24a, a SATA connector 25a, and a power connector 26a. To be more specific, the 4-pin male fan header 23a has a PWM pin, a Tach pin, a power supply pin and a ground pin, and the 3-pin male fan header (5V3P or 12V3P) has a Tach pin, a power supply pin, and a ground pin. Moreover, the power connector 26a is for use in connection with a power supply unit (PSU) disposed in the computer case, and the SATA connector 25a is for being connected to with a SATA connector disposed on the mother board through a SATA cable.

In addition, for meeting user needs, a cooling fan module 1c consisting of multiple case fans 11c is further developed and rolled out, and is illustrated in FIG. 4. Particularly, each said case fan 11c is provided with a first connection interface 12c includes a first male electrical connector 121c and a first female electrical connector 122c they all have a PWM pin, a power supply pin and a ground pin. To be more specific, the second (i.e., the left one) of the two case fans 11c is connected to the first female electrical connector 122c of the first (i.e., the right one) of the two case fans 11c by the first male electrical connector 121c thereof.

Moreover, the cooling fan module 1c further comprises a second connection interface 13c including a second male electrical connector 131c, a second female electrical connector 132c and a third female electrical connector 133c, of which the second female electrical connector 132c has a PWM pin, a power supply pin and a ground pin, and is adapted for being connected to the first male electrical connector 121c of the first case fan 11c. On the other hand, the second male electrical connector 131c and the third female electrical connector 133c all have a PWM pin, a Tach pin (or called as FG pin), a power supply pin, and a ground pin. By such arrangements, the rotation speed of the fan blade of each said case fan 11c can be controlled by PWM signal. However, owing to the fact that the second male electrical connector 131c only has one Tach pin for FG signal transmitting, there is merely the first case fan 11c able to output FG signal (i.e. signal in response to the rotation speed of fan blade) via the Tach pin thereof. In other words, it can only monitor the rotation speed of the first case fan 11c while the cooling fan module 1c is employed. Moreover, it is worth further explained that, despite the fact that the rotation speed of each said case fan 11c can be controlled by PWM signal, it is unable to control the rotation speed of the first or the second case fan 11c individually.

In accordance with this reason, a new type of cooling fan module 1d is hence developed and rolled out with reference to FIG. 5. As FIG. 5 illustrates, the cooling fan module 1d consisting of multiple case fans 11d, in which any two of the multiple case fans 11d are connected through a particularly-designed electrical connection interface. In addition, the cooling fan module 1d has a signal cable connected with a I2C connector 12d for being connected to a cooling fan control box including at least one I2C connector. It should be known that the I2C connector 12d has an SDA pin and an SCL pin, such that each said case fan 11d is allowed to transmit FG signal to the cooling fan control box 2a, and the cooling fan control box is also able to control the rotation speed of three case fans 11d individually.

Practical experience reveals that, in case of at least one said ARGB case fan 1b (as FIG. 2 shows) or at least one cooling fan module 1c (as FIG. 4 shows) being in connection with the cooling fan control box, FG signal would be transmitted in a BUS line, and a control chip is configured to calculate fan rotation speed by taking the pulses of the FG signal. In this case, if there is one cooling fan module 1d connected to the cooling fan control box, the cooling fan module 1d would transmit an SDA signal (i.e., FG signal) to the I2C connector of the cooling fan control box, such that the SDA signal is subsequently transmitted in the BUS line, thereby causing the FG signal of the ARGB case fan 1b or the cooling fan module 1c be influenced by the SDA signal. As a result, the influenced FG signal leads the control chip to be unable to dominate the fan rotation speed correctly.

It is sure that user can select to additionally buy one new type of cooling fan control box that has at least one I2C connector, thereby using the cooling fan control box to control and monitor the new type of cooling fan module 1d. However, it is not difficult to understand that, in case of user already having one cooling fan control box (as FIG. 3 shows), to buy another one new type of cooling fan control box including at least one I2C connector certainly increases the user's device cost. Particularly, as explained herein, the traditional cooling fan 1a of FIG. 1, the ARGB case fan 1b of FIG. 2 and the cooling fan module 1c are all abbreviated to “normal fan (N-fan)”, whereas the cooling fan module 1d is abbreviated to “digital fan (D-fan)”. Correspondingly, the cooling fan control box of FIG. 3 can be called as N-fan hub, and the foregoing new type of cooling fan control box including at least one I2C connector can be called as D-fan control box.

According to above descriptions, it is understood that there is a need to improve or re-design said D-fan, so as to develop a new type of D-fan which is compatible with the N-fan hub and the D-fan hub. Moreover, in case of there being at least one FG signal transmitted in the BUS line of the N-fan hub, connecting the new type of D-fan to the N-fan hub would not lead the FG signal to be influenced. In view of that, inventors of the present application have made great efforts to make inventive research and eventually provided a smart fan compatible with various control box.

### SUMMARY OF THE INVENTION

The primary objective of the present invention is to provide a smart fan able to be compatible with various cooling fan control box, wherein the smart fan has an electronic chip and at least one electrical connector. Particularly, the electronic chip is configured to, in case of the electrical connector being connected to a cooling fan control box, conduct an operation mode control of the smart fan based on the detection of FG signal that is transmitted in a BUS line of the cooling fan control box, so as to eventually switch the smart fan to work in a normal control mode or a data packet transmission mode. When being switched to the normal control mode, the electronic chip assigns the smart fan a priority identifier or a non-priority identifier, and then the smart fan works in the normal control mode. In addition, after being switched to the data packet transmission mode, the smart fan transmits a first data packet to or receive a second data packet from the cooling fan control box according to a communication protocol, such that a rotation speed control, a rotation speed monitoring and a function setting of the smart fan are carried out.

In order to achieve the aforementioned objective, one embodiment of the smart fan is provided, which has an electronic chip and at least one electrical connector, and the electronic chip is configured to:
conduct, in case of the electrical connector being connected to a cooling fan control box, a plurality of control operations, comprising:
switching, in case of the smart fan being powered on or reset, the smart fan to work in a normal control mode;
switching, in case of there being no a data packet transmission mode switching signal detected in the normal control mode, the smart fan to work in a priority identifier setting mode;
switching, after a priority identifier setting operation of the smart fan is conducted in the priority identifier setting mode, the smart fan to work in the normal control mode, such that in the normal control mode the smart fan is controlled to: receive a rotation speed controlling signal from the cooling fan control box as well as transmit a rotation speed signal to the cooling fan control box; or be stopped transmitting the rotation speed signal to the cooling fan control box;
switching, in case of the data packet transmission mode switching signal being detected in the normal control mode, the smart fan to work in a data packet transmission mode; and
controlling, in the data packet transmission mode, the smart fan to transmit a first data packet to the cooling fan control box or receive a second data packet from the cooling fan control box, such that a rotation speed control, a rotation speed monitoring and a function setting of the smart fan are carried out.

In one embodiment, the smart fan transmits the first data packet to or receives the second data packet from the cooling fan control box according to a communication protocol that is selected from a group consisting of UART communication protocol, I2C communication protocol, SPI communication protocol, 1-wire communication protocol, and PLC communication protocol.

In one embodiment, in case of there being no the data packet transmission mode switching signal detected within a first time period as the smart fan works in the normal control mode, the electronic chip switches the smart fan to work in the priority identifier setting mode.

In one embodiment, after transmitting a notification signal to the cooling fan control box through the electrical connector and subsequently receiving the data packet transmission mode switching signal from the cooling fan control box, the electronic chip switches the smart fan to work in the data packet transmission mode.

In one practicable embodiment, the electronic chip is further configured to:
conduct, in case of there being no at least one FG signal detected to be transmitted in a BUS line of the cooling fan control box before entering the priority identifier setting mode, a plurality of setting operations, comprising:
waiting a delay time;
controlling, the smart fan to transmit a specific signal to the cooling fan control box through the electrical connector; and
assigning, the smart fan that is the first to output the specific signal a priority identifier;
wherein the specific signal includes a low-level pulse.

In one embodiment, the smart fan having the priority identifier is able to receive the rotation speed controlling signal from the cooling fan control box as well as transmit the rotation speed signal to the cooling fan control box.

In one embodiment, in case of there being the FG signal detected to be transmitted in the BUS line of the cooling fan control box before entering the priority identifier setting mode, the electronic chip assigns the smart fan a non-priority identifier.

In one embodiment, the electronic chip assigns the smart fan that is not the first to output the specific signal the non-priority identifier, such that the smart fan having the non-priority identifier is able to receive the rotation speed controlling signal from the cooling fan control box, and is stopped transmitting the rotation speed signal to the cooling fan control box.

In one embodiment, in case of there being no at least one FG signal detected to be transmitted in the BUS line of the cooling fan control box in the data packet transmission mode, the electronic chip controls the smart fan to communicate with the cooling fan control box according to the communication protocol.

In one embodiment, in case of there being the FG signal detected to be transmitted in the BUS line in the data packet transmission mode, the electronic chip switches the smart fan to work in the normal control mode after assigning the smart fan a non-priority identifier.

In one embodiment, the smart fan having the non-priority identifier is stopped transmitting the rotation speed signal to the cooling fan control box.

In one embodiment, the smart fan further has a plurality of LED components, and the function setting of the smart fan is selected from a group consisting of work mode switching, fan identifier checking, group identifier checking, identifier re-assigning, and light emitting control of the plurality of LED components.

In one practicable embodiment, the electronic chip is further configured t:
switch, in case of receiving a first switching signal transmitted from the cooling fan control box in the data packet transmission mode, the smart fan to work in the normal control mode.

In another one practicable embodiment, the electronic chip is further configured to:
switch, in case of receiving a second switching signal transmitted from the cooling fan control box in the data packet transmission mode, the smart fan to work in an identifier checking and setting mode; and
switch, after completing a fan identifier checking operation, a group identifier checking operation and/or an identifier re-assigning operation, the smart fan to work in the data packet transmission mode.

In further another one practicable embodiment, the electronic chip is further configured to:
switch, in case of receiving a third switching signal transmitted from the cooling fan control box in the data packet transmission mode, the smart fan to work in a LED light controlling mode;
switch, in case of receiving a fourth switching signal transmitted from the cooling fan control box in the LED light controlling mode, the smart fan to work in the data packet transmission mode; and
switch, in case of the smart fan being powered on or reset in the LED light controlling mode, the smart fan to work in the normal control mode.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a top view of a traditional cooling fan.

FIG. 2 shows a top view of a currently popular ARGB case fan.

FIG. 3 shows a top view of a controller module of a conventional cooling fan control box.

FIG. 4 shows a stereo diagram of a cooling fan module consisting of multiple case fans.

FIG. 5 shows a top view of a new type of cooling fan module consisting of multiple case fans.

FIG. 6 shows a stereo diagram of a smart fan compatible with various control box according to the present invention.

FIG. 7A shows a first stereo diagram of a cooling fan module consisting of multiple smart fans according to the present invention.

FIG. 7B shows a second stereo diagram of the cooling fan module.

FIG. 8 shows a top view of a cooling fan control box.

FIG. 9 shows a first state diagram of the smart fan shown in FIG. 6 or the smart fan shown in FIG. 7A.

FIG. 10 shows a timing diagram of a rotation speed signal that is transmitted in a BUS line of the cooling fan control box and a power signal.

FIG. 11 shows a second state diagram of the smart fan shown in FIG. 6 or the smart fan shown in FIG. 7A.

### DETAILED DESCRIPTION OF THE PREFERRED EMBODIMENTS

To more clearly describe a smart fan compatible with various control box according to the present invention, embodiments of the present invention will be described in detail with reference to the attached drawings hereinafter.

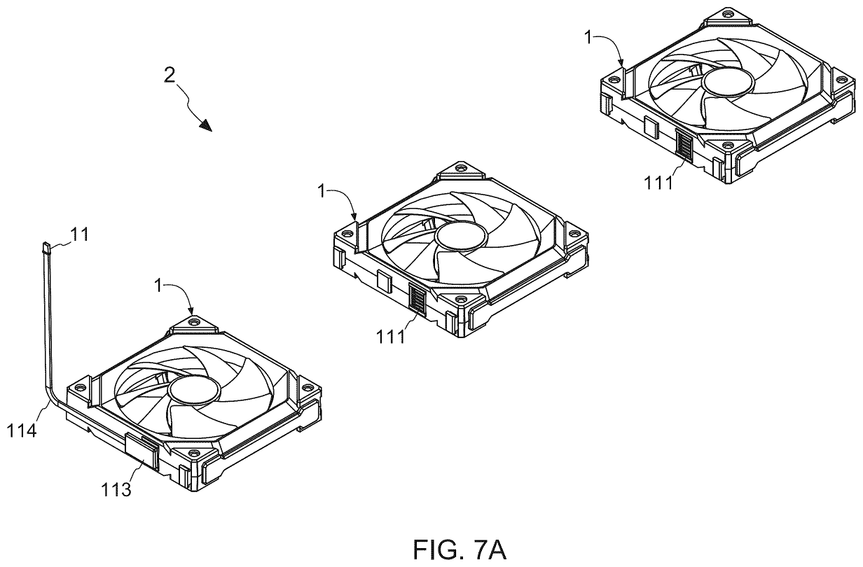

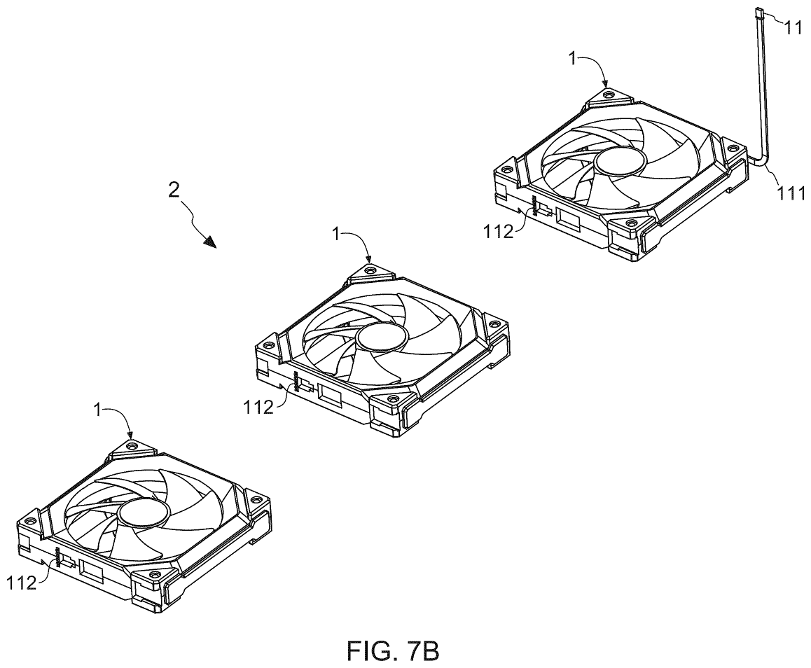

FIG. 6 illustrates a stereo diagram of a smart fan compatible with various control box according to the present invention. As FIG. 6 shows, the smart fan 1 is provided with an electronic chip 10 therein. Furthermore, FIG. 7A and FIG. 7B illustrate a first stereo diagram and a second stereo diagram of a cooling fan module that consists of three smart fans. As FIG. 6, FIG. 7A and FIG. 7B show, the smart fan 1 is provided with a first connection interface 111 and a second connection interface 112. As such, after making the first connection interface 111 of one smart fan 1 be connected to the second connection interface 112 of another one smart fan 1, two or more smart fans 1 can be assembly as one cooling fan module 2 (or called as cooling fan group).

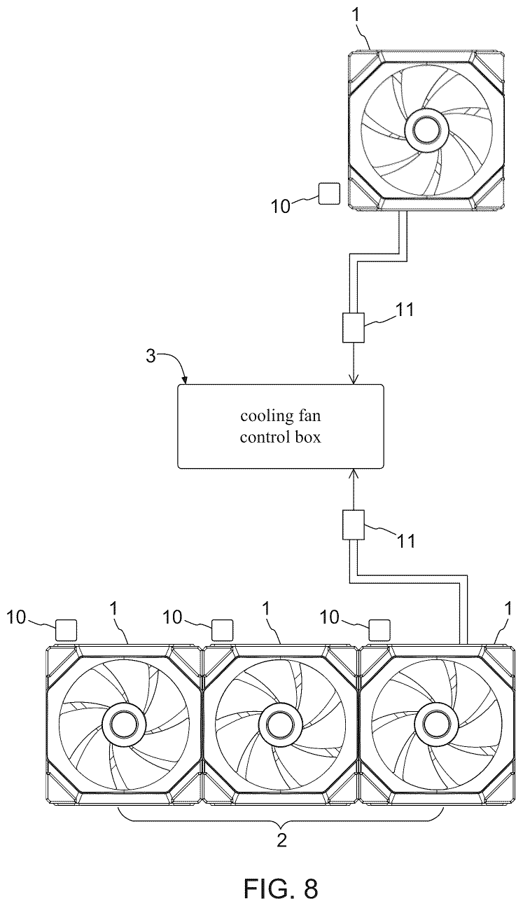

To be more specific, the smart fan 1 further includes a signal cable 114, wherein one end of the signal cable 114 is connected with a connection interface 113 for use in connection with the first connection interface 111, and another one end of the signal cable 114 is connected with an electrical connector 11. Therefore, as FIG. 8 shows, the smart fan 1 is controlled by a cooling fan control box 3 after connecting the electrical connector 11 to the cooling fan control box 3. Similarly, the cooling fan module 2 is also controlled by the identical cooling fan control box 3 after the electrical connector 11 of the first of the three smart fans 1 is connected to the cooling fan control box 3.

Particularly, the electronic chip 10 of the smart fan 1 is configured to conduct, in case of the electrical connector 11 being connected to the cooling fan control box 3, a plurality of control operations. It is worth further explaining that, the cooling fan control box 3 may be a normal type of control box or a new type of control box. As described in more detail below, a normal type of control box is abbreviated to “N-fan control box”, and includes multiple 4-pin male fan headers and multiple 3-pin male fan headers, of which the 4-pin male fan header has a PWM pin, a Tach pin, a power supply pin and a ground pin, and the 3-pin male fan header (5V3P or 12V3P) has a Tach pin, a power supply pin and a ground pin.

On the other hand, a new type of control box is abbreviated to “D-fan control box”, and includes multiple 4-pin male fan headers, multiple 3-pin male fan headers and at least one I2C connection interface, wherein the I2C interface has an SDA pin and an SCL pin, such that each of the three smart fans 1 of the cooling fan module 2 is allowed to transmit FG signal to the new-type of cooling fan control box 3 (i.e., D-fan control box), and the new-type of cooling fan control box 3 is also able to control the rotation speed of three smart fans 1 individually. It needs to explain that, in a practicable embodiment the SDA pin and SCL pin can also be adapted for transmitting the FG signal and the rotation speed controlling signal (i.e. PWM signal), respectively.

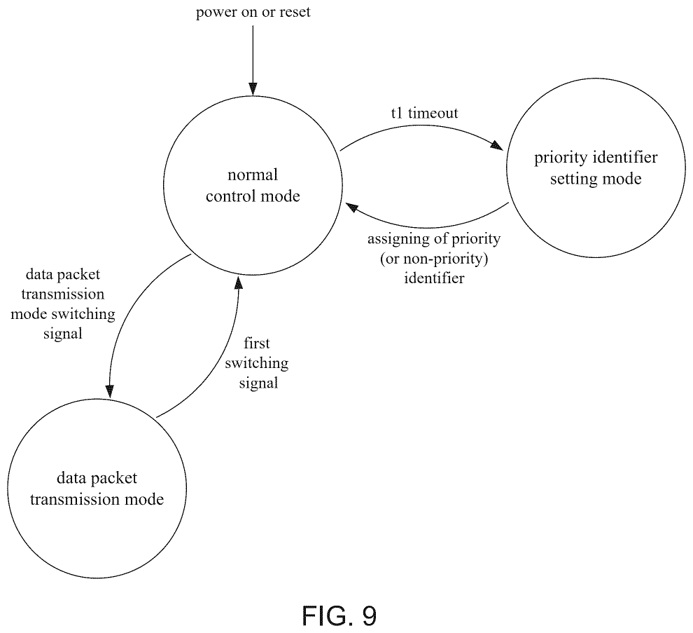

Furthermore, there is a first state diagram of the smart fan 1 shown in FIG. 6 or the smart fan 1 shown in FIG. 7A provided in FIG. 9. As FIG. 8 and FIG. 9 show, the electronic chip 10 is configured to conduct, in case of the electrical connector 11 being connected to the cooling fan control box 3, a plurality of control operations, comprising:
switching, in case of the smart fan 1 being powered on or reset, the smart fan 1 to work in a normal control mode;
switching, in case of there being no a data packet transmission mode switching signal detected in the normal control mode, the smart fan 1 to work in a priority identifier setting mode;
switching, after a priority identifier setting operation of the smart fan 1 is conducted in the priority identifier setting mode, the smart fan 1 to work in the normal control mode, such that in the normal control mode the smart fan 1 is controlled to: receive a rotation speed controlling signal (i.e., PWM signal) from the cooling fan control box 3 as well as transmit a rotation speed signal (i.e., FG signal) to the cooling fan control box 3; or be stopped transmitting the rotation speed signal to the cooling fan control box 3;
switching, in case of the data packet transmission mode switching signal being detected in the normal control mode, the smart fan 1 to work in a data packet transmission mode; and
controlling, in the data packet transmission mode, the smart fan 1 to transmit a first data packet to the cooling fan control box 3 or receive a second data packet from the cooling fan control box 3, such that a rotation speed control, a rotation speed monitoring and a function setting of the smart fan are carried out.

Briefly speaking, the electronic chip 10 automatically switches the smart fan 1 to work in a normal control mode while the electrical connector 11 of the smart fan 1 (or the cooling fan module 2) is connected to one cooling fan control box 3. To be more specific, the electronic chip 10 is configured to regard the cooling fan control box as an N-fan control box by default. As such, in the normal control mode, there are a first signal pin and a second signal pin of the electrical connector 11 adapted for transmitting of PWM signal and FG signal, respectively.

Moreover, in the normal control mode the electronic chip 10 is also configured to detect whether at least one FG signal or a data packet transmitted in a BUS line of the cooling fan control box 3. If yes, the electronic chip 10 transmits a notification signal to the cooling fan control box 3 in a time period of BUS idle, wherein an example of the notification signal is a specific signal including a low-level pulse. Therefore, in case of the cooling fan control box 3 generates a data packet transmission mode switching signal serving as a reply signal in response to the notification signal, the electronic chip 10 is informed by the data packet transmission mode switching signal so as to regard the cooling fan control box as a D-fan control box. On the contrary, if the cooling fan control box 3 does not transmit the aforesaid reply signal to the electronic chip 10, the cooling fan control box 3 is regarded as a N-fan control box by the electronic chip 10. In this case, the electronic chip 10 assigns the smart fan 1 a non-priority identifier, and controls the smart fan 1 to continuously work in the normal control mode.

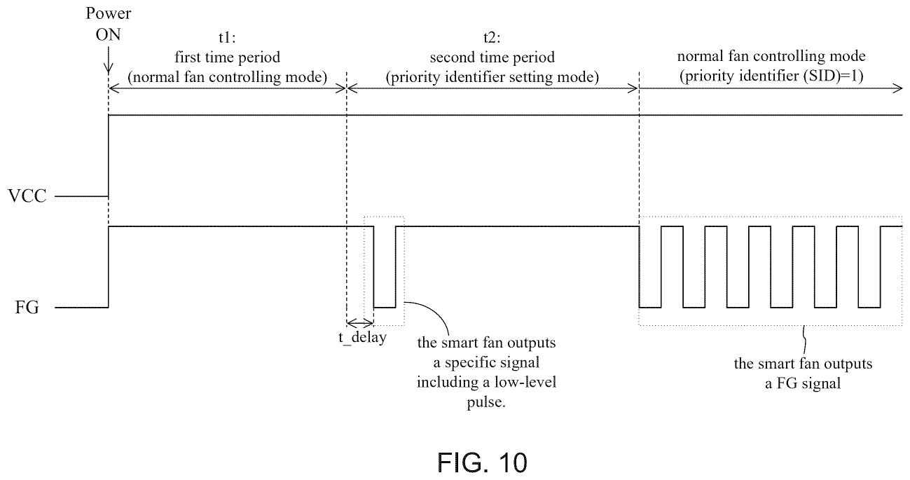

FIG. 10 is a timing diagram of a rotation speed signal (i.e., FG signal) that is transmitted in a BUS line of the cooling fan control box 3 and a power signal. As FIG. 10 shows, after the electrical connector 11 is connected to the cooling fan control box 3, a power supply pin of the electrical connector 11 receives a DC power (VCC) signal from the cooling fan control box 3, such that the smart fan 1 is powered on. In this case, the electronic chip 10 switches the smart fan 1 to work in a normal control mode, and then detects whether a data packet transmission mode switching signal transmitted by the cooling fan control box 3 within a first time period (i.e., t1) as the smart fan 1 works in the normal control mode. It should be understood that, the electronic chip 10 fails to receive the data packet transmission mode switching signal while the cooling fan control box 3 is a N-fan control box instead of a D-fan control box. As a result, the electronic chip 10 assigns the smart fan 1 a non-priority identifier, and controls the smart fan 1 to continuously work in the normal control mode.

To be described in more detail below, the electronic chip 10 is further configured to conduct, in case of there being no at least one FG signal detected to be transmitted in a BUS line of the cooling fan control box 3 before entering the priority identifier setting mode, a plurality of setting operations. In one embodiment, the plurality of setting operations comprises:
waiting a delay time (i.e., t_delay as shown in FIG. 10);
controlling, the smart fan 1 to transmit a specific signal including a low-level pulse to the cooling fan control box 3 through the electrical connector 11; and
assigning, the smart fan 1 that is the first to output the specific signal a priority identifier (e.g., SID=1 as shown in FIG. 10).

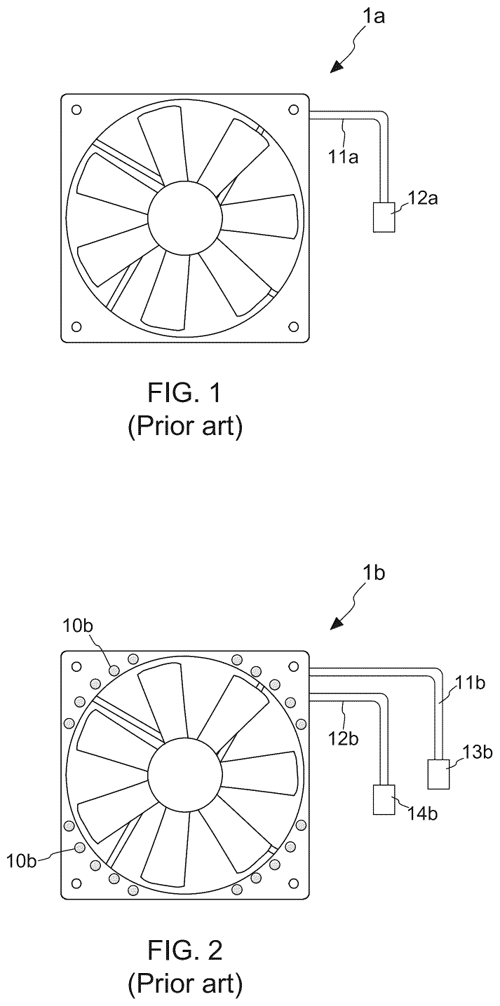

Briefly speaking, in case of the cooling fan control box 3 being not connected with at least one normal fan (e.g., the traditional cooling fan 1a of FIG. 1, the ARGB case fan 1b of FIG. 2 and/or the cooling fan module 1c of FIG. 4), there is not at least one FG signal transmitted in the BUS line of the cooling fan control box 3. In this case, after one cooling fan module 2 or two smart fans 1 are connected to the cooling fan control box 3, the electronic chip 10 conducts a priority identifier setting operation so as to assign the smart fan 1 that is the first to output the specific signal a priority identifier (e.g. SID=1). Moreover, the electronic chip 10 assigns the other smart fans 1 they are not the first to output the specific signal the non-priority identifier (e.g., SID=127). It is worth explaining that “SID” is the abbreviation of slave ID. Of course, in case of there is only one smart fan 1 connected to the cooling fan control box 3, the electronic chip 10 directly assigns the smart fan 1 the priority identifier (SID=1).

In other words, if the cooling fan control box 3 is already connected with at least one normal fan, at least one FG signal would be transmitted in the BUS line of the cooling fan control box 3. To be explained in more detail, the rotation speed of a cooling fan (or called as case fan) is commonly 120-120000 RPM, such that the FG signal outputted by the cooling fan has a duty cycle of 50% and a frequency of 4-4 KHz. Therefore, in the first time period (i.e., in t1) the electronic chip 10 is configured to conduct a signal toggling check of a specific signal that is transmitted in the BUS line of the cooling fan control box 3, thereby calculating the duty cycle and the frequency of the specific signal. As a result, if the calculated duty cycle is 50% and/or the frequency is calculated to be in the range between 4 Hz and 4 KHz, the specific signal is therefore identified as an FG signal. In this case, the electronic chip 10 assigns the smart fan 1 that is connected to the cooling fan control box 3 a non-priority identifier (e.g., SID=127), such that the smart fan 1 having the non-priority identifier is able to receive the rotation speed controlling signal (i.e., PWM signal) from the cooling fan control box 3. Moreover, the smart fan 1 having the non-priority identifier is stopped transmitting the rotation speed signal (i.e., FG signal) to the cooling fan control box 3, thereby preventing the FG signal originally transmitted in the BUS line from influence or disturbance.

In any practicable embodiments, said priority identifier is not limited to be SID=1, and said non-priority identifier is also not limited to be SID=127. In other words, engineers can set suitable SID values for the priority identifier and the non-priority identifier based on an actual application demand.

As FIG. 8 and FIG. 9 show, after receiving the data packet transmission mode switching signal transmitted from the cooling fan control box 3 (i.e., there is a data packet transmission mode switching signal detected), the electronic chip 10 switches the smart fan 1 to be work in a data packet transmission mode. As such, the smart fan 1 is able to, according to a communication protocol, transmit a first data packet to the cooling fan control box 3 or receive a second data packet from the cooling fan control box 3, such that a rotation speed control, a rotation speed monitoring and a function setting of the smart fan 1 are carried out. In any practicable embodiments, the communication protocol can be, but is not limited to UART communication protocol, I2C communication protocol, SPI communication protocol, 1-wire communication protocol, or PLC communication protocol.

Subsequently, in case of there being no at least one FG signal detected to be transmitted in the BUS line of the cooling fan control box 3 in the data packet transmission mode, the electronic chip 10 firstly reads a fan identifier from the smart fan 1 or a group identifier from the cooling fan module 2, and then controls the smart fan 1 or the cooling fan module 2 to communicate with the cooling fan control box 3 according to the communication protocol.

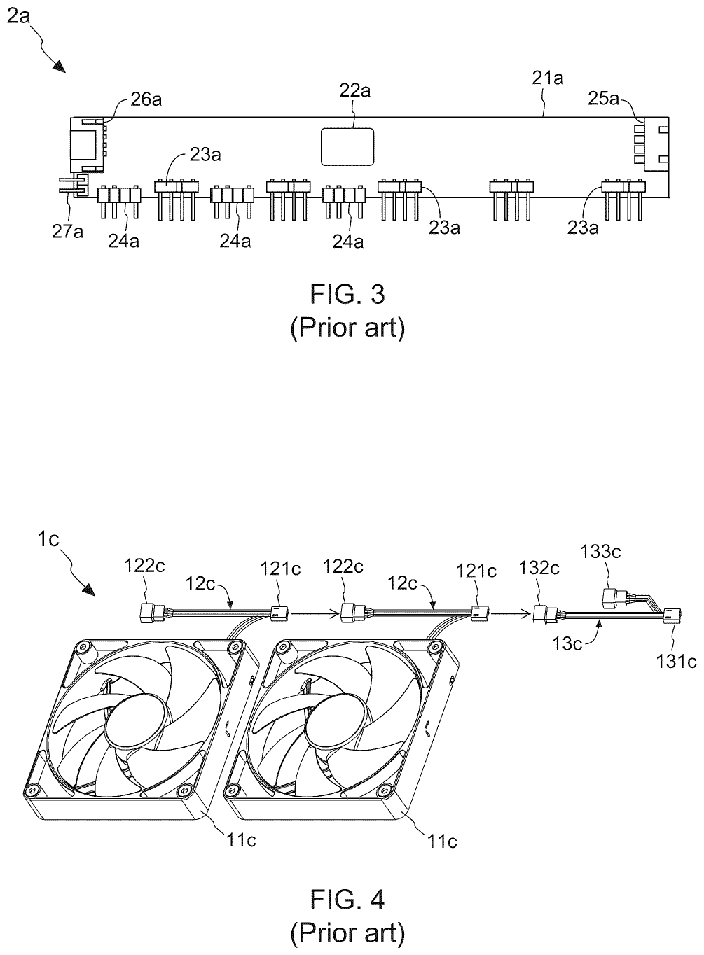

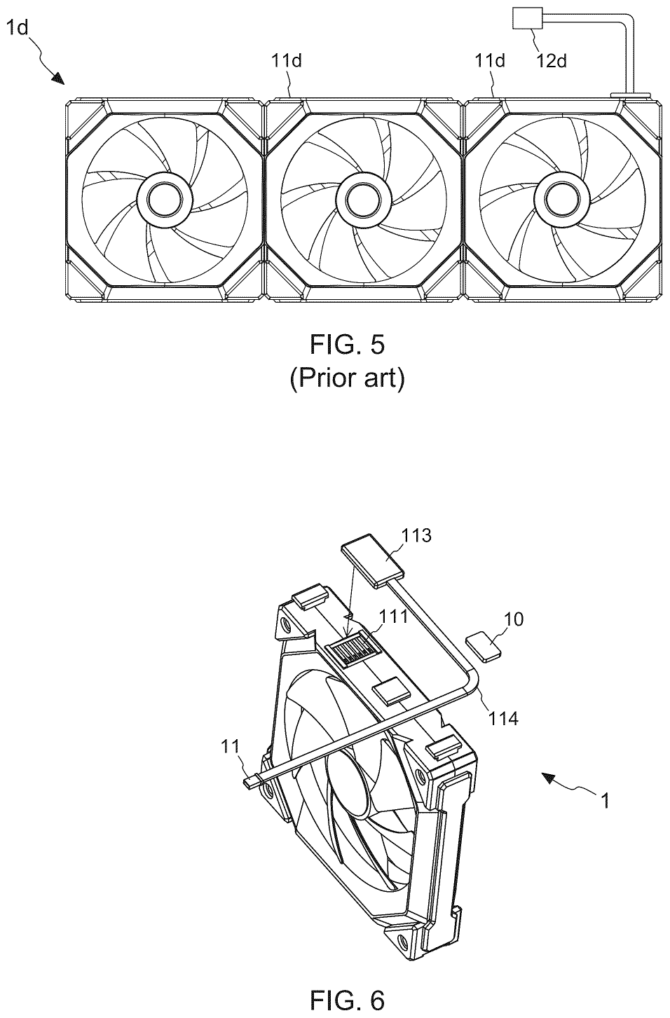

Particularly, as explained again herein, the traditional cooling fan 1a of FIG. 1, the ARGB case fan 1b of FIG. 2 and the two case fans 11c are all abbreviated to “normal fan (N-fan)”, whereas the three case fans 11d of FIG. 5 and the smart fan 1 of FIG. 6 are all abbreviated to “digital fan (D-fan)”. Correspondingly, the cooling fan control box of FIG. 3 can be called as N-fan hub, and a new type of cooling fan control box including at least one specific interface for use in transmitting data packet can be called as D-fan control box. For example, the specific interface can be a I2C interface including an SDA pin and an SCL pin, such that each of the three case fans 11d as shown in FIG. 5 and the smart fan 1 as shown in FIG. 8 are allowed to transmit a digital-form FG signal to the D-fan control box, and the D-fan control box is also able to control, by a digital-form rotation speed controlling signal, the rotation speed of three case fan 11d and the smart fan 1 individually. As described in more detail below, in the data packet transmission mode the electronic chip 10 converts the rotation speed signal (i.e., FG signal) to be a first digital code such as binary code, and then integrates the first digital code into the first data packet. As such, the D-fan control box (i.e., the cooling fan control box 3) processes the first data packet so as to acquire a current value of the rotation speed of the smart fan 1. Similarly, the D-fan control box converts the rotation speed controlling signal (i.e., PWM signal) to be a second digital signal, and then integrates the second digital code into the second data packet. Therefore, the electronic chip 10 of the smart fan 1 processes the second data packet so as to acquire a current rotation speed setting value, thereby controlling the motor to drive the fan blade to rotate by a corresponding rotation speed.

On the contrary, in the data packet transmission mode the electronic chip 10 detects that there is at least one FG signal transmitted in the BUS line of the cooling fan control box 3, the electronic chip 10 regards the cooling fan control box 3 as a N-fan control box. In this case the electronic chip 10 switches, as FIG. 8 and FIG. 9 show, the smart fan 1 to work in the normal control mode after assigning the smart fan 1 a non-priority identifier (e.g., SID=127). As such, the smart fan 1 having the non-priority identifier is stopped transmitting the rotation speed signal (i.e., FG signal) to the N-fan control box (i.e., the cooling fan control box 3), thereby preventing the FG signal originally transmitted in the BUS line from influence or disturbance.

According to the present invention, the D-fan control box (i.e., the cooling fan control box) is able to conduct at least one function setting of the smart fan 1 by transmitting the second data packet to the smart fan 1 (or the cooling fan module 2). As FIG. 8 and FIG. 9 show, the function settings comprise work mode switching, fan identifier checking, group identifier checking, and identifier re-assigning. Furthermore, in some embodiments the smart fan 1 may further has a plurality of LED components, and in such case the function settings further comprise light emitting control of the plurality of LED components. For example, in case of receiving a first switching signal transmitted from the cooling fan control box 3 in the data packet transmission mode, the electronic chip 10 switch the smart fan 1 to work in the normal control mode, thereby carrying out one kind of function setting of the smart fan 1. To be more specific, in a practical operation the first switching signal can be a general call with parse command (GC with CMD) or a third digital code embedded in the second data packet.

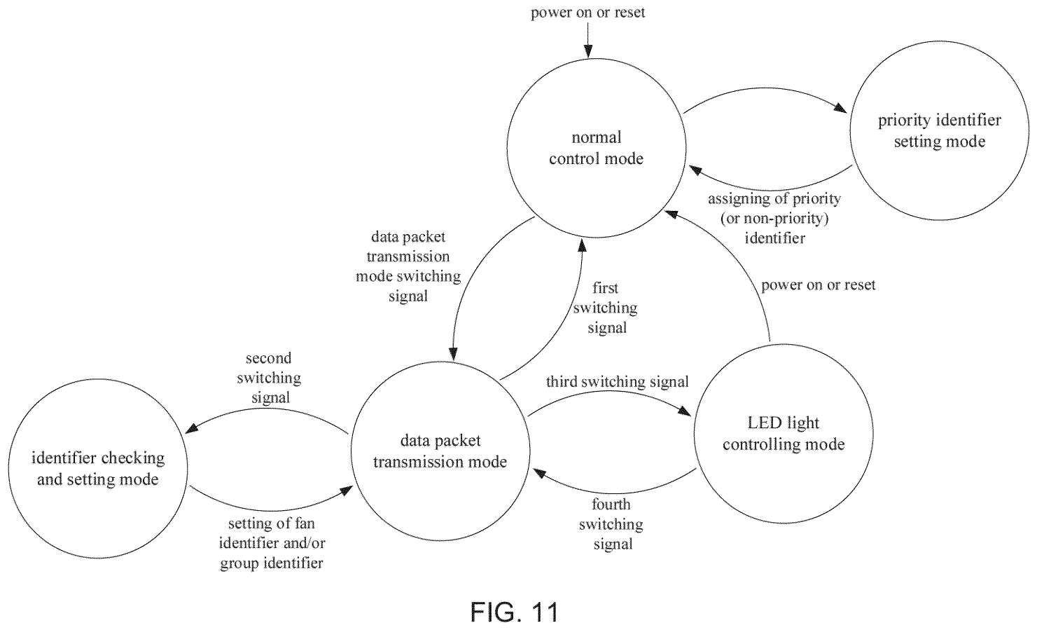

In addition, FIG. 11 illustrates a second state diagram of the smart fan shown in FIG. 6 or the smart fan shown in FIG. 7A. As FIG. 8 and FIG. 11 show, the items of function setting of the smart fan also comprise fan identifier checking, group identifier checking and identifier re-assigning. It is worth explaining that, in case of the electronic chip 10 not detecting least one FG signal transmitted in the BUS line of the cooling fan control box 3 in the data packet transmission mode, the cooling fan control box 3 reads the fan identifier (SID) from the smart fan 1 or the group identifier (GID) from the cooling fan module 2, thereby transmitting the second data packet to or receiving the first data packet from the smart fan 1 according to the specific communication protocol like I2C. Moreover, in order to guarantee that the cooling fan control box 3 is able to carry out the rotation speed controlling and monitoring, the electronic chip 10 switch the smart fan 1 to work in an identifier checking and setting mode while receiving a second switching signal transmitted from the cooling fan control box in the data packet transmission mode. As such, the electronic chip 10 is configured to conduct a fan identifier checking operation, a group identifier checking operation and/or an identifier re-assigning operation, and the switch the smart fan 1 back to the data packet transmission mode.

Taking I2C communication protocol as an example of the specific communication protocol, the fan identifier checking operation comprises following steps:
receiving, from the cooling fan control box 3, an identifier data for use in detection of I2C arbitration lost;
transmitting, in case of I2C arbitration lost being detected, a SID duplication notification signal to the cooling fan control box 3; and
receiving, from the cooling fan control box 3, a SID setting notification signal in response to the SID duplication notification signal.

To be more specific, the SID duplication notification signal generated by the electronic chip 10 that is integrated in the smart fan 1 can be a negative acknowledgment (NACK) signal, and has a low-level pulse.

Engineers skilled in I2C communication technology certainly know that, there are two common ways for conducting the fan identifier setting and/or the group identifier setting. One way is that the cooling fan control box 3 transmits a general call with SID to the smart fan 1, and the other way is that the cooling fan control box 3 transmits a general call with parse command (GC with CMD) to the smart fan 1. Similarly, the electronic chip 10 is able to conduct a group identifier checking operation of the cooling fan module 2 in cooperation with the cooling fan control box 3, of which the group identifier checking operation comprises following steps:
receiving, from the cooling fan control box 3, a GID data for use in determining whether an original group ID of the cooling fan module 2 is duplicated; and
transmitting, in case of the original group ID and GID being not identical, a corresponding notification signal like a NACK signal to the cooling fan control box 3.

In a practical operation, the cooling fan control box 3 is able to transmit a general call with CMD to the electronic chip 10, thereby activating the electronic chip 10 is conduct a group identifier setting (set GID) operation, of which the group identifier setting operation comprises following step:
replacing, after receiving a GID data including a specific group ID from the cooling fan control box 3, the original group ID with the specific group ID.

As FIG. 8 and FIG. 11 show, the electronic chip 10 switches, after completing the fan identifier checking operation, the group identifier checking operation and/or the identifier re-assigning operation, the smart fan 1 back to the data packet transmission mode.

Furthermore, the other one item of the function setting of the smart fan 1 is light emitting control of the plurality of LED components. As FIG. 8 and FIG. 11 show, the electronic chip 10 is configured to switch, in case of receiving a third switching signal transmitted from the cooling fan control box 3 in the data packet transmission mode, the smart fan 1 to work in an LED light controlling mode. In the LED light controlling mode, the digital rotation speed signal (i.e., the aforesaid first digital code) is transmitted to the cooling fan control box 3 through the SDA pin of the electrical connector 11, and the LED light controlling data is receiving from the cooling fan control box 3 via the SCL pin of the electrical connector 11.

Moreover, in the LED light controlling mode the electronic chip 10 switches, in case of receiving a fourth switching signal transmitted from the cooling fan control box 3, the smart fan 1 to work in the data packet transmission mode. On the other hand, the electronic chip 10 is configured to switch, in case of the smart fan 1 being powered on or reset in the LED light controlling mode, the smart fan 1 to work in the normal control mode.

Therefore, in above descriptions, the smart fan 1 compatible with various control box according to the present invention have been introduced completely and clearly. In summary, the smart fan 1 according to the present invention includes following merits:
(1) the smart fan 1 is compatible with both the conventional cooling fan control box (i.e., N-fan control box) including multiple 4-pin male fan headers and multiple 3-pin male fan headers and a new type of cooling fan control box (i.e., D-fan control box) which includes at least one specific communication interface like I2C interface.
(2) While being connected to a N-fan control box, the electronic chip 10 assigns the smart fan 1 a priority identifier (e.g., SID=1), so as to control the smart fan 1 to receive a rotation speed controlling signal from the N-fan control box as well as transmit a rotation speed signal to the N-fan control box.
(3) While being connected to a N-fan control box that has been connected with at least one case fan, the electronic chip 10 assigns the smart fan 1 a non-priority identifier (e.g., SID=127), such that the smart fan 1 is controlled to receive the rotation speed controlling signal from the N-fan control box as well as stopped transmitting the rotation speed signal to the N-fan control box.
(4) While being connected to a D-fan control box, the electronic chip 10 switches the smart 1 fan to work in a data packet transmission mode, such that the smart fan 1 is controlled to, according to a specific communication protocol, transmit a first data packet to and receive a second data packet from the D-fan control box, thereby carrying out a rotation speed control, a rotation speed monitoring and a function setting of the smart fan 1.
(5) The items of the function setting of the smart fan 1 comprises: work mode switching, fan identifier checking, group identifier checking, identifier re-assigning, and light emitting control of LED components.

The above description is made on embodiments of the present invention. However, the embodiments are not intended to limit scope of the present invention, and all equivalent implementations or alterations within the spirit of the present invention still fall within the scope of the present invention.

What is claimed is:

1. A smart fan, having an electronic chip and at least one electrical connector, wherein the electronic chip is configured to:
conduct, in case of the electrical connector being connected to a cooling fan control box, a plurality of control operations, comprising:
switching, in case of the smart fan being powered on or reset, the smart fan to work in a normal control mode;
switching, in case of there being no a data packet transmission mode switching signal detected in the normal control mode, the smart fan to work in a priority identifier setting mode;
switching, after a priority identifier setting operation of the smart fan is conducted in the priority identifier setting mode, the smart fan to work in the normal control mode, such that in the normal control mode the smart fan is controlled to: receive a rotation speed controlling signal from the cooling fan control box as well as transmit a rotation speed signal to the cooling fan control box; or be stopped transmitting the rotation speed signal to the cooling fan control box;
switching, in case of the data packet transmission mode switching signal being detected in the normal control mode, the smart fan to work in a data packet transmission mode; and
controlling, in the data packet transmission mode, the smart fan to transmit a first data packet to the cooling fan control box or receive a second data packet from the cooling fan control box, such that a rotation speed control, a rotation speed monitoring and a function setting of the smart fan are carried out.

2. The smart fan of claim 1, wherein the smart fan transmits the first data packet to or receives the second data packet from the cooling fan control box according to a communication protocol that is selected from a group consisting of UART communication protocol, I2C communication protocol, SPI communication protocol, 1-wire communication protocol, and PLC communication protocol.

3. The smart fan of claim 1, wherein in case of there being no the data packet transmission mode switching signal detected within a first time period as the smart fan works in the normal control mode, the electronic chip switching the smart fan to work in the priority identifier setting mode.

4. The smart fan of claim 1, wherein after transmitting a notification signal to the cooling fan control box through the electrical connector and subsequently receiving the data packet transmission mode switching signal from the cooling fan control box, the electronic chip switching the smart fan to work in the data packet transmission mode.

5. The smart fan of claim 3, wherein the electronic chip is further configured to:
conduct, in case of there being no at least one FG signal detected to be transmitted in a BUS line of the cooling fan control box before entering the priority identifier setting mode, a plurality of setting operations, comprising:
waiting a delay time;
controlling, the smart fan to transmit a specific signal to the cooling fan control box through the electrical connector; and
assigning, the smart fan that is the first to output the specific signal a priority identifier;
wherein the specific signal includes a low-level pulse.

6. The smart fan of claim 5, wherein the smart fan having the priority identifier is able to receive the rotation speed controlling signal from the cooling fan control box as well as transmit the rotation speed signal to the cooling fan control box.

7. The smart fan of claim 5, wherein in case of there being the FG signal detected to be transmitted in the BUS line of the cooling fan control box before entering the priority identifier setting mode, the electronic chip assigning the smart fan a non-priority identifier.

8. The smart fan of claim 7, wherein the electronic chip assigns the smart fan that is not the first to output the specific signal the non-priority identifier, such that the smart fan having the non-priority identifier is able to receive the rotation speed controlling signal from the cooling fan control box, and is stopped transmitting the rotation speed signal to the cooling fan control box.

9. The smart fan of claim 2, wherein in case of there being no at least one FG signal detected to be transmitted in a BUS line of the cooling fan control box in the data packet transmission mode, the electronic chip controlling the smart fan to communicate with the cooling fan control box according to the communication protocol.

10. The smart fan of claim 9, wherein in case of there being the FG signal detected to be transmitted in the BUS line in the data packet transmission mode, the electronic chip switching the smart fan to work in the normal control mode after assigning the smart fan a non-priority identifier.

11. The smart fan of claim 10, wherein the smart fan having the non-priority identifier is stopped transmitting the rotation speed signal to the cooling fan control box.

12. The smart fan of claim 1, wherein the smart fan further has a plurality of LED components, and the function setting of the smart fan being selected from a group consisting of work mode switching, fan identifier checking, group identifier checking, identifier re-assigning, and light emitting control of the plurality of LED components.

13. The smart fan of claim 12, wherein the electronic chip is further configured to:
switch, in case of receiving a first switching signal transmitted from the cooling fan control box in the data packet transmission mode, the smart fan to work in the normal control mode.

14. The smart fan of claim 13, wherein the electronic chip is further configured to:
switch, in case of receiving a second switching signal transmitted from the cooling fan control box in the data packet transmission mode, the smart fan to work in an identifier checking and setting mode; and
switch, after completing a fan identifier checking operation, a group identifier checking operation and/or an identifier re-assigning operation, the smart fan to work in the data packet transmission mode.

15. The smart fan of claim 14, wherein the electronic chip is further configured to:
switch, in case of receiving a third switching signal transmitted from the cooling fan control box in the data packet transmission mode, the smart fan to work in a LED light controlling mode;
switch, in case of receiving a fourth switching signal transmitted from the cooling fan control box in the LED light controlling mode, the smart fan to work in the data packet transmission mode; and
switch, in case of the smart fan being powered on or reset in the LED light controlling mode, the smart fan to work in the normal control mode.
